(19) United States
(12) Patent Application Publication
(10) Pub. No.: US 2025/0338005 A1
(43) Pub. Date: Oct. 30, 2025

(54) IMAGING APPARATUS AND CONTROL METHOD OF IMAGING APPARATUS

(71) Applicant: CANON KABUSHIKI KAISHA, Tokyo (JP)

(72) Inventor: YUTA KAWAMURA, Kanagawa (JP)

(21) Appl. No.: 19/173,977

(22) Filed: Apr. 9, 2025

(30) Foreign Application Priority Data
Apr. 25, 2024 (JP) 2024-071824

(51) Int. Cl. H04N 23/611

(52) U.S. Cl. CPC H04N 23/611

(57) ABSTRACT

An imaging apparatus includes a processor, and a memory storing a program which, when executed by the processor, causes an imaging apparatus to execute tracking processing of detecting and tracking one or more first parts and one or more second parts from a captured image to execute acquisition processing of acquiring a combination of a first part and a second part of a same object from the one or more first parts and the one or more second parts and to execute detection processing of detecting the first part of a main object from the one or more first parts using a reference image of the main object, and detecting, as the second part of the main object, the second part selected from the one or more second parts as a part of the same object as the first part of the main object.

### CROSS-REFERENCE TO PRIORITY APPLICATION

This application claims the benefit of Japanese Patent Application No. 2024-071824, filed on Apr. 25, 2024, which is hereby incorporated by reference herein in its entirety.

### BACKGROUND OF THE INVENTION

### Field of the Invention

The present invention relates to an imaging apparatus and a control method of the imaging apparatus.

### Description of the Related Art

In continuous imaging or moving image capturing, in a case where a plurality of moving objects is detected and imaged, it is desirable that the imaging apparatus determines a main object from the plurality of objects and keeps focusing on the main object.

JP 2023-106907 A discloses a method of detecting a plurality of parts from an object and tracking the object on the basis of a result of search processing of each part.

In JP 2023-106907 A, since the result of search processing of the priority part among the plurality of parts is prioritized, in a case where the priority part is erroneously tracked, the imaging apparatus may determine an object different from the intention of the user as the main object, and focus on the erroneously determined main object.

### SUMMARY OF THE INVENTION

The present invention provides a technique for more accurately tracking an object intended by a user even in a case where a plurality of different objects are present in a captured image.

An imaging apparatus according to the present invention includes a processor, and a memory storing a program which, when executed by the processor, causes an imaging apparatus to execute tracking processing of detecting and tracking one or more first parts and one or more second parts from a captured image, to execute acquisition processing of acquiring a combination of a first part and a second part of a same object from the one or more first parts and the one or more second parts, and to execute detection processing of detecting the first part of a main object from the one or more first parts using a reference image of the main object, and detecting, as the second part of the main object, the second part selected from the one or more second parts as a part of the same object as the first part of the main object.

Further features of the present invention will become apparent from the following description of exemplary embodiments with reference to the attached drawings.

### BRIEF DESCRIPTION OF THE DRAWINGS

FIG. 1 is a block diagram illustrating a configuration of an imaging apparatus;

FIG. 2 is a block diagram illustrating a detailed configuration of an object detection unit;

FIG. 3 is a flowchart illustrating object detection processing;

FIGS. 4A and 4B are diagrams for explaining sizes and gravity center positions of a plurality of parts to be detected;

FIGS. 5A and 5B are diagrams for explaining a change in a gravity center position between frames of a part to be detected;

FIG. 6 is a diagram for explaining determination as to whether a plurality of parts are parts of the same object; and

FIGS. 7A to 7C are diagrams for explaining an example of tracking processing.

### DESCRIPTION OF THE EMBODIMENTS

Hereafter, embodiments of the present invention will be described with reference to the drawings. For example, the imaging apparatus according to the present embodiment tracks the face and the upper body of the main object, and can correctly track the main object by using the result of the face authentication of the main object even if erroneous tracking is started for the upper body that can acquire a larger feature amount than the face.

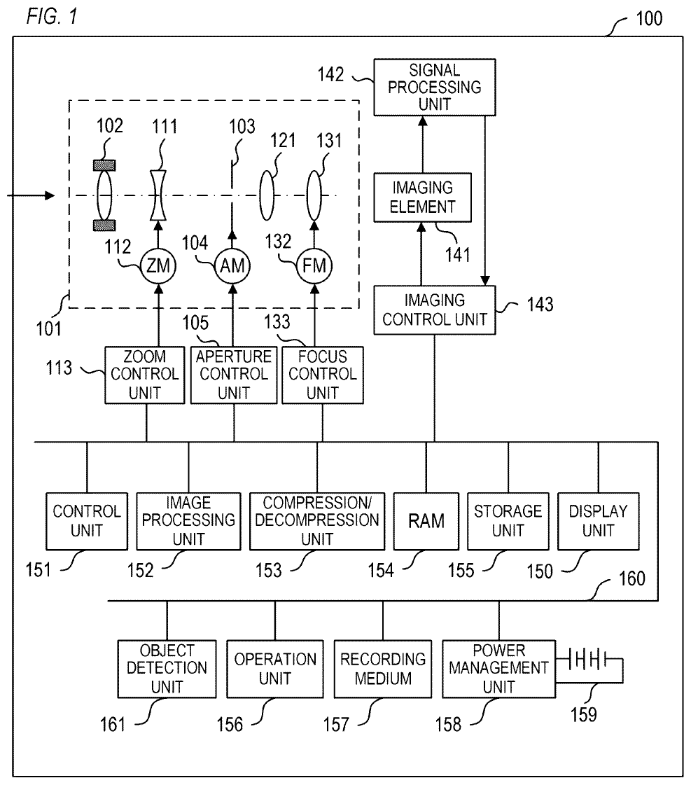

FIG. 1 is a block diagram illustrating a configuration of an imaging apparatus 100. The imaging apparatus 100 is a digital still camera, a video camera, or the like capable of capturing and recording a moving image and a still image. The units in the imaging apparatus 100 are communicably connected to each other via a bus 160. The operation of the imaging apparatus 100 is realized by a control unit 151 (central processing unit) executing a program to control each unit.

A lens unit 101 (imaging lens) includes a fixed-first-group lens 102, a zoom lens 111, an aperture 103, a fixed-third-group lens 121, a focus lens 131, a zoom motor 112, an aperture motor 104, and a focus motor 132. An imaging optical system of the imaging apparatus 100 includes the fixed-first-group lens 102, the zoom lens 111, the aperture 103, the fixed-third-group lens 121, and the focus lens 131. Note that the lens included in the imaging optical system is illustrated as one lens, but each lens may include a plurality of lenses. The lens unit 101 may be an interchangeable lens unit (interchangeable lens) detachable from the imaging apparatus 100.

An aperture control unit 105 controls the operation of the aperture motor 104 that drives the aperture 103, and adjusts the light amount at the time of imaging by adjusting an aperture diameter of the aperture 103. A zoom control unit 113 controls the operation of the zoom motor 112 that drives the zoom lens 111 to change the focal length (angle of view) of the lens unit 101.

A focus control unit 133 acquires a defocus amount and a defocus direction of the lens unit 101 on the basis of a phase difference between a pair of focus detection signals (A image and B image) obtained from an imaging element 141. The focus control unit 133 determines the drive amount and the drive direction of the focus motor 132 on the basis of the defocus amount and the defocus direction. The focus control unit 133 controls the focus adjustment of the lens unit 101 by moving the focus lens 131 by controlling the operation of the focus motor 132 on the basis of the determined drive amount and drive direction. The focus control unit 133 can realize automatic focus detection (autofocus, AF) of a phase detection autofocus by controlling focus adjustment of the lens unit 101. Note that the focus control unit 133 may realize AF by a contrast detection system of controlling focus adjustment of the lens unit 101 by moving the focus lens 131 on the basis of a contrast evaluation value of an image signal obtained from the imaging element 141.

The object image formed on the image forming surface of the imaging element 141 by the lens unit 101 is converted into an electrical signal (image signal) by a photoelectric conversion element included in each of a plurality of pixels arranged in the imaging element 141. In the imaging element 141, m pixels in the horizontal direction and n pixels in the vertical direction (m and n are natural numbers) are arranged in a matrix. Each pixel has two photoelectric conversion elements (photoelectric conversion regions). The control unit 151 can acquire an image of the imaging surface by adding the outputs of the two photoelectric conversion elements. Furthermore, the control unit 151 can acquire two images (parallax images) having different parallaxes by separately processing the outputs of the two photoelectric conversion elements.

An imaging control unit 143 controls reading of an image signal from the imaging element 141 in accordance with an instruction from the control unit 151. The image signal read from the imaging element 141 is supplied to a signal processing unit 142. The signal processing unit 142 applies signal processing such as noise reduction processing, A/D conversion processing, and automatic gain control processing to the image signal, and outputs the image signal to the imaging control unit 143. The imaging control unit 143 accumulates the image signal (image data) received from the signal processing unit 142 in a random-access memory (RAM) 154.

An image processing unit 152 applies predetermined image processing to the image data accumulated in a RAM 154. The image processing applied to the image data by the image processing unit 152 includes, but is not limited to, signal format conversion processing, scaling processing, and the like in addition to development processing such as white balance adjustment processing, color interpolation (demosaic) processing, and gamma correction processing. The image processing unit 152 can also generate information regarding object luminance for use in automatic exposure control (AE).

The information regarding the specific region of object may be supplied from an object detection unit 161 and used for the white balance adjustment processing, for example. Note that, in a case where AF of the contrast detection method is performed, the AF evaluation value may be generated by the image processing unit 152. The image processing unit 152 stores image data obtained by applying image processing to the image data in the RAM 154.

In a case where the image data stored in the RAM 154 is recorded in the recording medium 157, the control unit 151 adds a predetermined header to the image processing data, for example, to generate a data file according to the recording format. The control unit 151 may compress the amount of information by encoding the image data using a compression/decompression unit 153. The control unit 151 records the generated data file in recording medium 157 such as a memory card.

To display the image data stored in the RAM 154, the control unit 151 causes the image processing unit 152 to scale the image data to fit the display size on a display unit 150. The control unit 151 writes the scaled image data in an area (VRAM area) used as a video memory in the RAM 154. The display unit 150 reads image data for display from the VRAM area of the RAM 154 and displays the image data on a display device such as a liquid crystal display (LCD) or an organic electro-luminescence (EL) display.

The imaging apparatus 100 can cause the display unit 150 to function as an electronic viewfinder (EVF) by immediately displaying a captured moving image on the display unit 150 in a standby state of a still image or during recording of a moving image. When the display unit 150 is caused to function as the EVF, the moving image displayed on the display unit 150 and the frame image included in the moving image are referred to as a live view image or a through-the-lens image. When capturing a still image, the imaging apparatus 100 displays the captured still image on the display unit 150 for a certain period of time so that the user can confirm the captured still image. Image display processing on the display unit 150 is realized by control of the control unit 151.

An operation unit 156 includes a switch, a button, a key, a touch panel, a line-of-sight input device, and the like for the user to input an instruction to the imaging apparatus 100. A user's instruction input via the operation unit 156 is notified to the control unit 151 via the bus 160. The control unit 151 controls each unit of the imaging apparatus 100 to implement processing according to the user's instruction.

The control unit 151 includes one or more programmable processors such as a CPU and an MPU. For example, the control unit 151 reads a program stored in a storage unit 155 into the RAM 154 and executes the program, thereby controlling each unit to implement the function of the imaging apparatus 100.

The control unit 151 executes AE processing of automatically determining an exposure condition (shutter speed or accumulation time, aperture value, sensitivity) on the basis of the information of the object luminance. The object luminance information can be acquired from the image processing unit 152, for example. The control unit 151 can also determine the exposure condition with reference to a specific region such as a face of a person, for example.

The control unit 151 controls the exposure by adjusting the electronic shutter speed (accumulation time) and the magnitude of the gain. The control unit 151 notifies the imaging control unit 143 of the determined accumulation time and the magnitude of the gain. The imaging control unit 143 controls the operation of the imaging element 141 so that imaging according to the notified exposure condition is performed.

A power management unit 158 manages a battery 159. The battery 159 supplies power to the entire imaging apparatus 100. The storage unit 155 stores a program executed by the control unit 151, setting values used for executing the program, GUI data, user setting values, and the like. For example, when the user operates the operation unit 156 to instruct transition from the power-off state to the power-on state, the control unit 151 reads the program stored in the storage unit 155 into a part of the RAM 154 and executes the program, and turns on the power of the imaging apparatus 100 to start the processing.

The object detection unit 161 detects an object to be imaged. The object detection unit 161 has a function of detecting a part of the object. In addition, the object detection unit 161 has a function of detecting an object stored in the RAM 154 and a function of tracking a part of the detected object between captured images captured continuously. Furthermore, the object detection unit 161 has a function of detecting a first part (for example, a face) and a second part (for example, an upper body) of the object and determining whether the detected first part and second part are the same object.

The continuously captured images include a moving image. Each of the consecutively captured images corresponds to a frame of a moving image. In the following description, the object detection processing for each frame of the moving image will be described, but the present embodiment is applicable to captured images which were continuously captured.

For example, when the object is a person, the object detection unit 161 can detect a part such as a face and a torso, track each of the detected face and torso between a plurality of frames, and determine whether the tracked face and torso are parts of the same person.

A result of the processing by the object detection unit 161 is stored in the RAM 154 and used for tracking processing between frames, automatic setting of a focus detection region, and the like. By the processing of the object detection unit 161, the imaging apparatus 100 can realize a tracking AF function for a specific object. The imaging apparatus 100 can perform AE processing on the basis of luminance information of the focus detection region, and perform various types of image processing on the basis of pixel values of the focus detection region. The image processing here includes, for example, the gamma correction processing, the white balance adjustment processing, and the like.

The control unit 151 may superimpose and display an index indicating the region of the main object that is the object to be tracked on the display image. The indicator indicating the region of the main object is, for example, a rectangular frame surrounding the region of the main object.

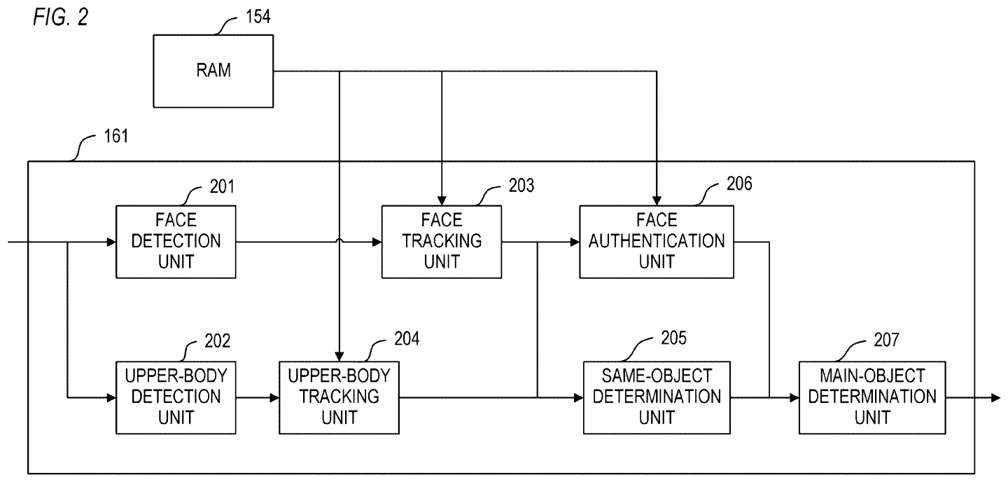

FIG. 2 is a block diagram illustrating a detailed configuration of the object detection unit 161. The object detection unit 161 includes a face detection unit 201, an upper-body detection unit 202, a face tracking unit 203, an upper-body tracking unit 204, a same-object determination unit 205, a face authentication unit 206, and a main-object determination unit 207. Each unit of the object detection unit 161 realizes each function under the control of the control unit 151.

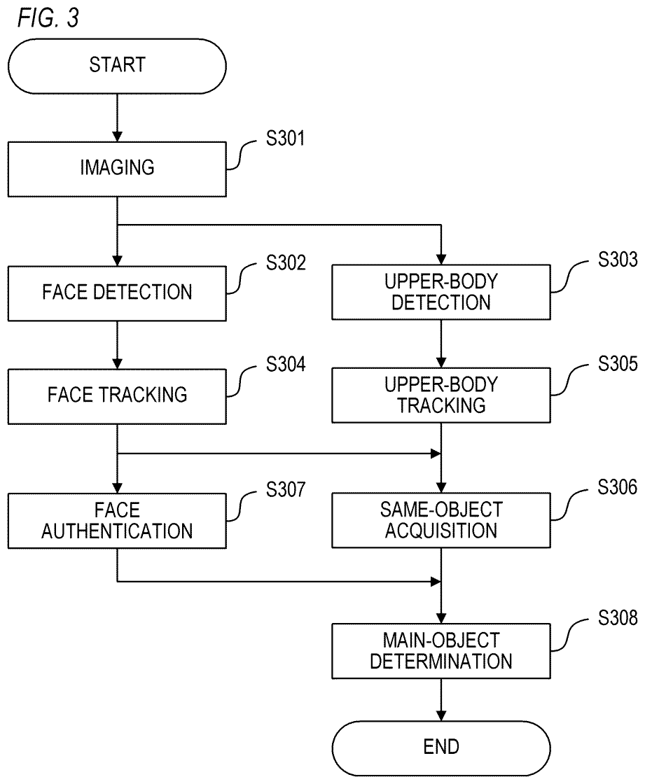

Subject detection processing executed by the object detection unit 161 will be described with reference to FIG. 3. FIG. 3 is a flowchart illustrating object detection processing; The processing of each step is realized by the control unit 151 controlling each unit of the imaging apparatus 100 and each unit of the object detection unit 161.

The object detection processing illustrated in FIG. 3 is started when the imaging apparatus 100 is powered on, a live view is displayed on the display unit 150, and an instruction to start capturing (recording) a still image or a moving image can be received by the operation unit 156. The object detection processing illustrated in FIG. 3 is processing executed for each captured image continuously captured (for each frame of the moving image).

FIG. 3 illustrates the object detection processing in which the face and the upper body of a person as a main object are detected and tracked, and a scene in which the main object is shielded by another person passing in front of the main object is assumed. When the person to be tracked is shielded by another person passing in front of the person to be tracked, the object detection unit 161 may end up falsely tracking either the face or the upper body of the other person in front. Note that the object detection processing illustrated in FIG. 3 is also applicable to other scenes where erroneous tracking may occur.

In step S301, the imaging control unit 143 controls the imaging element 141 to perform imaging processing. The signal processing unit 142 acquires a captured image obtained by A/D converting an image signal from the imaging element 141. The captured image here includes a frame of a moving image.

In step S302, the face detection unit 201 detects the face (corresponding to the first part) of the person (corresponding to the object) from the captured image acquired in step S301. In a case where there is a plurality of objects, the face detection unit 201 detects one or more faces. In step S303, the upper-body detection unit 202 detects the upper body (corresponding to the second part) of the person from the captured image acquired in step S301. In a case where there is a plurality of objects, the upper-body detection unit 202 detects one or more upper bodies.

In steps S302 and S303, the face detection unit 201 and the upper-body detection unit 202 can detect the face and the upper body, respectively, using a known method. For example, the face detection unit 201 can detect a face by performing feature extraction processing of a face that is a specific target by Convolutional Neural Networks (hereinafter, described as CNN.). In addition, by registering an image of a face of an object to be detected as a template in advance, the face detection unit 201 may detect the face of the object by template matching. The upper-body detection unit 202 can detect the upper body similarly to the face detection by the face detection unit 201. The method of detecting each part may be different for each part. In addition, a plurality of detection methods may be used in combination to detect one part.

In step S304, the face tracking unit 203 tracks the face between frames by using the detection result of the face detected in step S302 and the face of the past frame captured at another time stored in the RAM 154. In a case where there is a plurality of objects, the face tracking unit 203 tracks one or more faces detected by the face detection unit 201. In step S305, the upper-body tracking unit 204 tracks the upper body between frames by using the detection result of the upper body detected in step S303 and the upper body of the past frame captured at another time stored in the RAM 154. In a case where there is a plurality of objects, the upper-body tracking unit 204 tracks one or more upper bodies detected by the upper-body detection unit 202.

In steps S304 and S305, the face tracking unit 203 and the upper-body tracking unit 204 can track the face and the upper body, respectively, using a known method. For example, the face tracking unit 203 can register a face detected in a past frame stored in the RAM 154 as a template and perform tracking processing by template matching. In addition, the face tracking unit 203 may compare the positions of the faces detected in the frame image between frames and acquire a face within a range of a predetermined distance as a tracking result. The upper-body tracking unit 204 can track the upper body similarly to tracking of the face by the face tracking unit 203. The method of tracking each part may be different for each part. In addition, a plurality of tracking methods may be used in combination to track one part.

Although the face is detected as the first part in step S302 and the upper body is detected as the second part in step S303, the part to be detected is not limited to these parts. The object detection unit 161 may execute the object detection processing with the first part as a face and the second part as a pupil. Furthermore, the object detection unit 161 may execute the object detection processing with the first part as a pupil and the second part as a face.

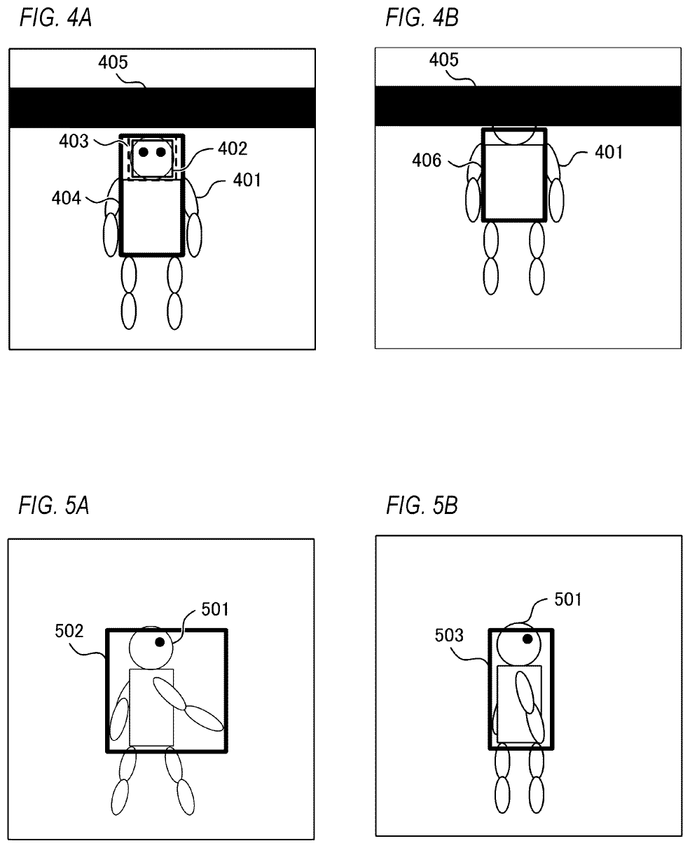

The first part and the second part are selected such that at least one of the gravity center position and the size is different. With reference to FIGS. 4A and 4B, an explanation will be given on the reason why parts having different gravity center positions or sizes are selected as the first part and the second part.

FIGS. 4A and 4B are frames captured at different times. As illustrated in FIG. 4A, the object detection unit 161 detects a face 402 and a head 403 of an object 401, for example. The face 402 and the head 403 have similar gravity center positions and sizes. In addition, an obstacle 405 is present above the object 401.

In FIG. 4B, the face 402 of the object 401 is hidden by the obstacle 405. In this case, the head 403 having substantially the same gravity center position and size as the face 402 is also hidden by the obstacle 405. Therefore, in a case where the first part is the face and the second part is the head, the object detection unit 161 may lose sight of the object 401.

On the other hand, an upper body 404 detected in the frame of FIG. 4A is detected as an upper body 406 in the frame of FIG. 4B even when the face 402 is hidden by the obstacle 405. By setting the upper body different in at least one of the gravity center position and the size from the face, which is the first part, as the second part, the object detection unit 161 can track the upper body 406 in step S305. The object detection unit 161 detects and tracks two parts having different gravity center positions or sizes, thereby suppressing loss of sight of both parts in the same frame and continuously tracking the object 401.

The first part and the second part are set such that a change in at least one of the gravity center position and the size between frames is smaller. With reference to FIGS. 5A and 5B, an explanation will be given on the reason why the first part and the second part are set such that the change in the gravity center position and the size between the frames is smaller.

FIGS. 5A and 5B are frames captured at different times. In FIGS. 5A and 5B, unlike FIGS. 4A and 4B, the upper body of an object 501 is detected as a region including arms.

FIGS. 5A and 5B illustrate a state in which the object 501 is walking while swinging arms back and forth. An upper body 502 detected in the frame of FIG. 5A indicates a state in which an arm of the object 501 is swung forward. An upper body 503 detected in the frame of FIG. 5B indicates a state in which the arm of the object 501 is located beside the body. In the upper body 502 and the upper body 503, the change in the gravity center position and the size between the frames is larger than the case where the arms are not included in the upper body, and the upper-body tracking unit 204 may fail the tracking processing in step S305.

Therefore, it is preferable that the part of the object 501 to be detected in steps S302 and S303 is a part having less change in at least one of the gravity center position and the size between the frames. By setting a part having a smaller change in the gravity center position and the size between frames as a tracking target, the tracking performance in steps S304 and S305 is improved.

In step S306, the same-object determination unit 205 determines whether the face detected and tracked in steps S302 and S304 and the upper body detected and tracked in steps S303 and S305 are parts of the same object.

In steps S302 and S304, one or more faces (first parts) are detected and tracked. Furthermore, in steps S303 and S305, one or more upper bodies (second parts) are detected and tracked. The same-object determination unit 205 determines whether each combination is a part of the same object from one or more tracked faces and one or more tracked upper bodies. The same-object determination unit 205 acquires a combination of the face and the upper body determined to be parts of the same object as the same object.

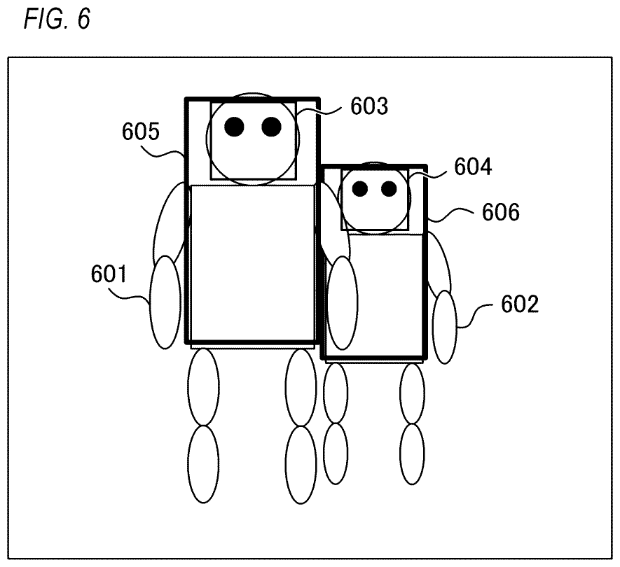

The processing in step S306 will be specifically described with reference to FIG. 6. A face 603 of an object 601 and a face 604 of an object 602 are tracking results of the faces detected in step S302 and tracked in step S304. An upper body 605 of the object 601 and an upper body 606 of the object 602 are the tracking results of the upper bodies detected in step S303 and tracked in step S305.

Since the face 603 is included in the upper body 605, the same-object determination unit 205 determines that the face 603 and the upper body 605 are parts of the same object 601. Similarly, since the face 604 is included in the upper body 606, the same-object determination unit 205 determines that the face 604 and the upper body 606 are parts of the same object 602. The same-object determination unit 205 acquires a combination of the face 603 and the upper body 605 as the object 601, and acquires a combination of the face 604 and the upper body 606 as the object 602. In this manner, the same-object determination unit 205 can determine that the first part and the second part are parts of the same object in a case where the region of the face that is the first part is included in the region of the upper body that is the second part in the captured image.

The same-object determination unit 205 is not limited to the case of determining that the face included in the upper body is the face of the same object as the upper body, and may determine whether the face and the upper body are parts of the same object by another method. For example, the same-object determination unit 205 may determine whether or not the face and the upper body are parts of the same object by executing the feature extraction processing using the gravity center position of the face and the gravity center position of the upper body as inputs using the CNN. That is, the same-object determination unit 205 can acquire a combination of the face and the upper body of the same object by using the trained model trained to output whether or not the face and the upper body are parts of the same object using the gravity center position of the face and the gravity center position of the upper body as inputs.

In step S307, the face authentication unit 206 performs face authentication processing by collating the face detected and tracked in steps S302 and S304 with a reference image of the face stored in advance in the RAM 154. The reference image of the face stored in the RAM 154 is, for example, an image of the face of the main object set in advance as the tracking target by the user. The face authentication unit 206 can detect the face of the main object from one or more faces detected in step S302 using the reference image of the main object.

Note that, in a case where the first part detected in step S302 is assumed to be a pupil and the second part detected in step S303 is assumed to be a face, the reference image stored in the RAM 154 may be an image of a pupil of the main object.

The face authentication unit 206 uses, for example, CNN to acquire feature amount of a reference image of the face of the main object stored in advance in the RAM 154 and feature amount of the face detected and tracked in steps S302 and S304, and calculates a similarity score. The face authentication unit 206 can use the cosine similarity score as the similarity score. The cosine similarity takes a real value between −1 and +1, and the closer to 1, the higher the similarity score.

The reference image stored in the RAM 154 is, for example, an image registered by the user. The user can select a face image stored in the recording medium 157 such as a memory card via the operation unit 156 and register the selected face image in the RAM 154 as a reference image.

In addition, the reference image may also be an image of the face detected as the face of the main object in main-object determination processing in step S308. The main-object determination unit 207 registers the image of the face detected as the face of the main object in the RAM 154 as a reference image.

Note that, in the object detection processing of FIG. 3, an example has been described in which the first part is a face and the face authentication is performed using the reference image of the face in step S307, but the first part is not limited to the face. The first part may be any part as long as the main object as a tracking target can be identified, and may be, for example, a pupil or an upper body wearing a uniform with a uniform number of an individual in a sports team. The RAM 154 may hold an image of a part corresponding to the first part of the main object as a reference image.

In step S308, the main-object determination unit 207 determines an object including the face authenticated in step S306 among the objects (combination of the face and the upper body of the same object) acquired in step S307 as the main object. That is, the main-object determination unit 207 detects, from the one or more upper bodies detected in step S303, the upper body selected as a part of the same object as the face of the main object as the upper body of the main object.

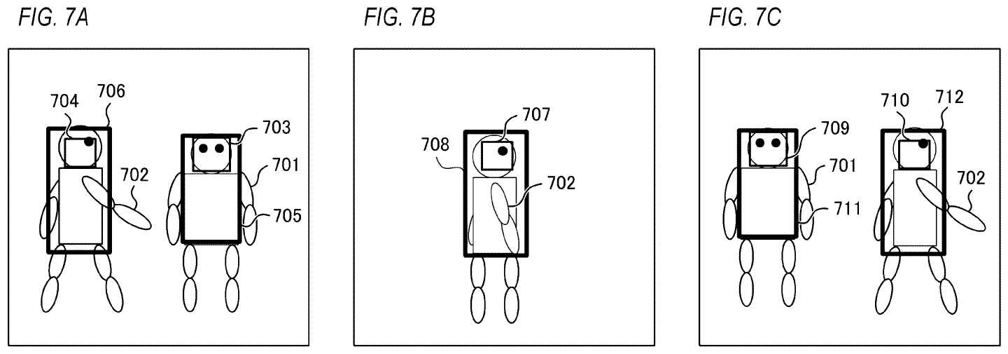

With reference to FIGS. 7A to 7C, an explanation will be given on processing of detecting the main object in a scene where two persons intersect. FIG. 7A illustrates an (n−2)th frame, FIG. 7B illustrates an (n−1)th frame, and FIG. 7C illustrates an nth frame that is a target of the main object detection processing.

The main object in FIG. 7A is an object 701. The main object may be an object set in advance as a tracking target by the user, or may be an object set by the imaging apparatus 100 on the basis of user's line-of-sight information or the like. A face 703 and an upper body 705 are parts of the object 701, and are determined to be parts of the same object in step S306. Similarly, a face 704 and an upper body 706 are parts of an object 702, and are determined to be parts of the same object in step S306. The object 701, which is the main object, faces the user, who is capturing an image. The object 702, which is a sub-object, is walking in a direction crossing in front of the object 701.

FIG. 7B illustrates a state in which the object 701 is temporarily hidden behind the object 702 when the object 702 crosses in front of object 701. In FIG. 7A, the face detection unit 201 detects two faces, the face 703 and the face 704. On the other hand, the face detected by the face detection unit 201 in FIG. 7B is one of faces 707.

In the frame illustrated in FIG. 7B, the face tracking unit 203 fails to track the face 703 or the face 704 in step S304. When the tracking processing by template matching is performed, the face tracking unit 203 detects the sideways face 707 as a tracking result of the sideways face 704. In addition, the face tracking unit 203 ends up determining that tracking of the face 703 has failed (lost).

Similarly for the upper body, the upper-body tracking unit 204 detects a sideways upper body 708 as a tracking result of the sideways upper body 706. Furthermore, the upper-body tracking unit 204 ends up determining that the tracking of the upper body 705 has failed (lost).

FIG. 7C illustrates a state after the object 702 passes in front of the object 701. The positional relationship between the object 701 and the object 702 in FIG. 7C is opposite to the positional relationship in FIG. 7A.

For example, in a case where the object 701 and the object 702 wear clothes of the same color and the same pattern, similar features are extracted from an upper body 711 and an upper body 712, and thus the upper-body tracking unit 204 may perform erroneous tracking in the tracking processing by template matching. Specifically, the upper-body tracking unit 204 may detect the upper body 708 of the object 702 in FIG. 7B as a tracking result of the upper body 705 of the object 701 in FIG. 7A. Also, in a case where the upper-body tracking unit 204 detects the upper body 708 of the object 702 in FIG. 7B as the tracking result of the upper body 706 of the object 702 in FIG. 7A, the upper-body tracking unit 204 may detect the upper body 711 of the object 701 as the tracking result of the upper body 708 in FIG. 7C.

Furthermore, for example, in a case where the object 701 and the object 702 wear clothes of different colors or different patterns, in a case where the position-based tracking processing is performed, the upper-body tracking unit 204 may erroneously track the upper body. Comparing FIGS. 7A and 7C, since the positional relationship between the object 701 and the object 702 is reversed, therefore the upper-body tracking unit 204 may detect the upper body 712 of the object 702 in FIG. 7C as a tracking result of the upper body 705 of the object 701 in FIG. 7A. Similarly for the face, the face tracking unit 203 may detect a face 710 of the object 702 in FIG. 7C as a tracking result of the face 703 of the object 701 in FIG. 7A.

Processing in which the same-object determination unit 205 detects the main object on the basis of the results of tracking the face and the upper body by template matching in steps S304 and S305 will be described. For example, an explanation will be given on determination (detection) of the main object in a case where the face has been correctly tracked but the tracking of the upper body has failed. An explanation will be given on a case where the face 703 of the object 701 facing the front in FIG. 7A is tracked as a face 709 of the object 701 in FIG. 7C, and the upper body 705 of the object 701 in FIG. 7A is erroneously tracked as the upper body 712 of the object 702 in FIG. 7C.

In step S306, the same-object determination unit 205 determines that the face 709 and the upper body 711 in the frame of FIG. 7C are parts of the same object, and detects a combination of the face 709 and the upper body 711 as the object 701. Further, the same-object determination unit 205 determines that the face 710 and the upper body 712 are parts of the same object, and detects a combination of the face 710 and the upper body 712 as the object 702. Therefore, the face 709 that is the tracking result of the face 703 of the object 701 and the upper body 712 that is the tracking result of the upper body 705 of the object 701 are determined as parts of different object in FIG. 7C.

In step S308, the main-object determination unit 207 acquires the object 701 including the face 709 and the object 702 including the upper body 712 as candidates of the main object in the frame of FIG. 7C. The main-object determination unit 207 can determine and detect the main object on the basis of the result of face authentication in step S307.

The main-object determination unit 207 acquires the similarity score (authentication score) between the face tracked in step S304 and the reference image of the face of the main object, and detects the face having the highest similarity score among the tracked faces as the face of the main object.

In the example of FIG. 7A, the main-object determination unit 207 calculates the authentication score of the face 709 and the face 710 using the reference image of the face of the object 701 that is the main object. The main-object determination unit 207 may use the image of the face 703 of the object 701 in FIG. 7A as the reference image of the main object. The authentication score of the face 709 is higher than the authentication score of the face 710. Therefore, in step S308, the main-object determination unit 207 detects the face 709 having a high authentication score as a part of the main object. The main-object determination unit 207 can detect, as the upper body of the main object, the upper body 711 acquired as a part of the same object as the face 709 in step S306.

In the above embodiments, the imaging apparatus 100 detects faces and upper bodies of a plurality of objects from captured image (frame) to be processed. The imaging apparatus 100 tracks each of the faces and the upper bodies of the plurality of objects, and detects the main object on the basis of the tracking result. In a case where the face tracking and the upper body tracking start tracking different objects, the imaging apparatus 100 can accurately determine the main object to be tracked from among the plurality of objects by performing the authentication processing of the tracked face using the reference image of the face of the main object. As a result, the imaging apparatus 100 can detect and track the main object according to the user's intention in the captured image in which a plurality of objects exists.

Note that, in step S307, in a case where any of the similarity scores between the one or more faces tracked in step S304 and the reference image of the main object are lower than the predetermined threshold, the main-object determination unit 207 determines the main object on the basis of the tracking result of the upper body. Specifically, the main-object determination unit 207 detects, as a face of the main object, a face determined to be a part of the same object as the upper body tracked as a part of the main object.

Even in a case where the reference image of the main object is not registered in the RAM 154 or the storage unit 155 in step S307, the main-object determination unit 207 can determine the main object on the basis of the tracking result of the upper body.

Furthermore, in the above embodiment, an example of tracking two parts of the object has been described, but the imaging apparatus 100 may track three or more parts. The imaging apparatus 100 can accurately detect the main object by performing the authentication processing using the reference image of the main object for any part of the three or more parts.

The present embodiment can also be realized by the following method. That is, the system or the apparatus includes a storage medium in which a program code of software in which a procedure for realizing the function of the present embodiment is described is recorded. A computer (or CPU, MPU, etc.) of the system or the apparatus reads and executes the program code stored in the storage medium. The program code read from the storage medium can implement the novel function according to the present embodiment, and the storage medium and the program storing the program code constitute the present invention.

Examples of the storage medium for supplying the program code include a flexible disk, a hard disk, an optical disc, and a magneto-optical disc. The storage medium may be a CD-ROM, a CD-R, a CD-RW, a DVD-ROM, a DVD-RAM, a DVD-RW, a DVD-R, a magnetic tape, a nonvolatile memory card, a ROM, or the like.

The functions of the present embodiment are implemented by enabling execution of a program code read by a computer. Furthermore, the functions of the present embodiment may be realized by an operating system (OS) or the like running on a computer performing a part or all of actual processing on the basis of an instruction of a program code.

The present embodiment may be implemented by the following method. First, the program code read from the storage medium is written in a memory included in a function expansion board inserted into the computer or a function expansion unit connected to the computer. The CPU or the like included in the function extension board or the function extension unit performs a part or all of actual processing on the basis of an instruction of a program code written in the memory.

According to the present invention, it is possible to more accurately track an object intended by a user even in a case where a plurality of different objects are present in a captured image.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present invention are also included in the present invention. The present invention also includes other configurations obtained by suitably combining various features of the embodiment.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An imaging apparatus comprising:
a processor; and
a memory storing a program which, when executed by the processor, causes an imaging apparatus:
to execute tracking processing of detecting and tracking one or more first parts and one or more second parts from a captured image;
to execute acquisition processing of acquiring a combination of a first part and a second part of a same object from the one or more first parts and the one or more second parts; and
to execute detection processing of detecting the first part of a main object from the one or more first parts using a reference image of the main object, and detecting, as the second part of the main object, the second part selected from the one or more second parts as a part of the same object as the first part of the main object.

2. The imaging apparatus according to claim 1, wherein at least one of a gravity center position and a size of the first part and the second part is different.

3. The imaging apparatus according to claim 1, wherein the first part and the second part are set such that a change in at least one of a gravity center position and a size between the captured images consecutively captured is smaller.

4. The imaging apparatus according to claim 1, wherein the first part is a face of a person.

5. The imaging apparatus according to claim 1, wherein the reference image is an image registered by a user.

6. The imaging apparatus according to claim 1, wherein, in the detection processing, an image of the first part detected as the first part of the main object is registered as the reference image.

7. The imaging apparatus according to claim 1, wherein, in the detection processing, a similarity score between each of the one or more first parts and the reference image is acquired, and the first part having the highest similarity score among the one or more first parts is detected as the first part of the main object.

8. The imaging apparatus according to claim 7, wherein, in the detection processing, in a case where the similarity score of each of the one or more first parts is lower than a predetermined threshold,
the second part of the main object is detected on a basis of a tracking result of the second part, and
the first part selected as a part of the same object as the second part of the main object is detected as the first part of the main object.

9. The imaging apparatus according to claim 1, wherein, in the detection processing, in a case where the reference image is not registered,
the second part of the main object is detected on a basis of a tracking result of the second part, and
the first part selected as a part of the same object as the second part of the main object is detected as the first part of the main object.

10. The imaging apparatus according to claim 1, wherein the first part is a part included in the second part, and,
in the acquisition processing, in a case where a region of the first part is included in a region of the second part in the captured image, the first part and the second part are determined to be a part of the same object.

11. The imaging apparatus according to claim 1, wherein, in the acquisition processing, a combination of the first part and the second part of the same object is acquired by using a learned model learned so as to use a gravity center position of the first part and a gravity center position of the second part as inputs and output whether or not the first part and the second part are parts of the same object.

12. A control method of an imaging apparatus, comprising steps of:
detecting and tracking one or more first parts and one or more second parts from a captured image;
acquiring a combination of a first part and a second part of a same object from the one or more first parts and the one or more second parts; and
detecting the first part of a main object from the one or more first parts using a reference image of the main object, and detecting, as the second part of the main object, the second part selected from the one or more second parts as a part of the same object as the first part of the main object.

13. A non-transitory computer readable medium that stores a program, wherein the program causes a computer to execute a control method of an imaging apparatus, the control method comprising steps of:
detecting and tracking one or more first parts and one or more second parts from a captured image;
acquiring a combination of a first part and a second part of a same object from the one or more first parts and the one or more second parts; and
detecting the first part of a main object from the one or more first parts using a reference image of the main object, and detecting, as the second part of the main object, the second part selected from the one or more second parts as a part of the same object as the first part of the main object.
